(19) United States
(12) Patent Application Publication
(10) Pub. No.: US 2010/0272067 A1
(43) Pub. Date: Oct. 28, 2010

(54) Carrier assignment with mobility support in multi-carrier OFDM systems

(75) Inventors: Hsiao-Chen Lu, Dashu Xiang (TW); Chih-Hsiang Tang, Taipei City (TW); Sheng-Wei Lin, Hsinchu City (TW); Wan-Jiun Liao, Taipei City (TW); I-Kang Fu, Taipei City (TW); Chao-Chin Chou, Taipei City (TW)

Correspondence Address: IMPERIUM PATENT WORKS, P.O. BOX 607, Pleasanton, CA, 94566, US

(73) Assignees: MEDIATEK INC; National Taiwan University

(21) Appl. No.: 12/799,361

(22) Filed: Apr. 23, 2010

Related U.S. Application Data
(60) Provisional application No. 61/172,344, filed on Apr. 24, 2009.

(51) Int. Cl. H04W 36/00

(52) U.S. Cl. 370/331

(57) ABSTRACT

Carrier pre-assignment is applied in multi-carrier handover operation to mitigate the impact to the user experience during handover and to achieve various objectives of call admission control in wireless multi-carrier OFDM networks. With carrier pre-assignment, a mobile station communicates its multi-carrier information to a target base station. The target base station pre-assigns secondary carriers to fulfill the requirements of the mobile station. In a first embodiment, a break-before-entry (BBE) multi-carrier handover procedure with carrier pre-assignment is provided. In a second embodiment, an entry-before-break (EBB) multi-carrier handover procedures for both inter-FA and intra-FA with carrier pre-assignment are provided. The multi-carrier handover procedures with carrier pre-assignment may be applied to 2-to-2 or N-to-N carriers handover situation. Because target secondary carriers are pre-assigned before handoff, the mobile station is ready for data transmission over multiple carriers after handover without additional carrier assignment procedure.

### CROSS REFERENCE TO RELATED APPLICATIONS

This application claims priority under 35 U.S.C. §119 from U.S. Provisional Application Ser. No. 61/172,344, entitled “Method of Capability Negotiation to Support Prioritized Carrier Assignment in OFDMA Multi-Carrier Systems,” filed on Apr. 24, 2009, the subject matter of which is incorporated herein by reference.

### TECHNICAL FIELD

The disclosed embodiments relate generally to wireless network communications, and, more particularly, to handover in multi-carrier wireless systems.

### BACKGROUND

In current wireless communication systems, 5MHz-20MHz radio bandwidths are typically used for up to 100Mbps peak transmission rate. Much higher peak transmission rate is required for next generation wireless systems. For example, 1Gbps peak transmission rate is required by ITU-R for IMT-Advanced systems such as the 4^{th} generation (“4G”) mobile communication systems. The current transmission technologies, however, are very difficult to perform 100 bps/Hz transmission spectrum efficiency. In the foreseeable next few years, only up to 15 bps/Hz transmission spectrum efficiency can be anticipated. Therefore, much wider radio bandwidths (i.e., at least 40 MHz) will be necessary for next generation wireless communication systems to achieve 1G bps peak transmission rate.

Orthogonal Frequency Division Multiplexing (OFDM) is an efficient multiplexing scheme to perform high transmission rate over frequency selective channel without the disturbance from inter-carrier interference. There are two typical architectures to utilize much wider radio bandwidth for OFDM system. In a traditional OFDM system, a single radio frequency (RF) carrier is used to carry one wideband radio signal, and in a multi-carrier OFDM system, multiple RF carriers are used to carry multiple radio signals with narrower bandwidth. A multi-carrier OFDM system has various advantages as compared to a traditional OFDM system such as lower Peak to Average Power Ratio, easier backward compatibility, and more flexibility. Thus, multi-carrier OFDM systems have become the baseline system architecture in IEEE 802.16m and LTE-Advanced draft standards to fulfill next generation wireless communication system requirements.

Handover is an important operation in wireless communication systems. FIG. 1 (Prior Art) illustrates system throughput during handover in a wireless multi-carrier OFDM network 10. Multi-carrier OFDM network 10 comprises a serving base station BS11 serving cell 14, a target base station BS12 serving cell 15, and a mobile station MS13. MS13 is initially connected to serving BS11 with one primary carrier and three active secondary carriers. When MS13 later moves to the cell edge of cell 14 and inside of cell 15, it decides to handover to target BS12. During handover re-entry, MS13 disconnects all its existing connections and establishes a new primary carrier connection to target BS12. As a result, existing data flows on the secondary carriers are interrupted. After the new primary carrier connection has been established, MS13 then receives multi-carrier information from target BS12 and exchanges control messages for secondary carrier configuration to reestablish new secondary carrier connections to target BS12. As illustrated in FIG. 1, the throughput of MS13 decreases after handoff and gradually increases when the new secondary carrier connections are established after exchanges of control messages for secondary carrier configuration. Thus, it is desirable to have a comprehensive solution to facilitate multi-carrier handover operation such that system performance degradation caused by handover can be reduced.

### SUMMARY

Carrier pre-assignment is applied in multi-carrier handover operation to mitigate the impact to the user experience during handover and to achieve various objectives of call admission control in a wireless multi-carrier OFDM network. In one novel aspect, a mobile station and a target base station negotiates their multi-carrier capability such that the target base station pre-assigns secondary carriers based on the negotiation result. Such negotiation is performed by exchanging handover request and handover command through a serving base station. First, the mobile station communicates its multi-carrier capability and requirements to the target base station via a handover request. Second, upon receiving the handover request, the target base station pre-assigns certain secondary carriers to fulfill the requirements of the mobile station via a handover command. For example, the pre-assignment decision may be based on a combination of the multi-carrier capability and preference of the mobile station, its QoS requirement, the traffic load of each secondary carrier, and other call admission control policies applied in the wireless multi-carrier OFDM network.

In a first embodiment, a break-before-entry (BBE) multi-carrier handover procedure with carrier pre-assignment is provided. A multi-carrier mobile station communicates with its serving base station over both a primary carrier and one or more secondary carriers. The MS receives a handover command from the serving base station and disconnects all connections from the serving BS. The handover command comprises carrier pre-assignment decision of a target base station. The MS then performs handover ranging and network reentry with the target BS on a target primary carrier. Finally, new connections on the target primary carrier and pre-assigned target secondary carriers are established simultaneously.

In a second embodiment, an entry-before-break (EBB) multi-carrier handover procedures for both inter-FA and intra-FA with carrier pre-assignment are provided. A multi-carrier mobile station communicates with its serving base station over both a primary carrier and one or more secondary carriers. The MS receives a handover command from the serving base station. The handover command comprises carrier pre-assignment decision of a target base station. The MS then performs handover ranging and network reentry with the target BS on a target primary carrier while maintains data communication with the serving BS. The MS establishes a new connection on the target primary carrier and disconnects all connections from the serving BS. Finally, subsequent new connections on pre-assigned target secondary carriers are established.

The multi-carrier handover procedures with carrier pre-assignment may be applied to 2-to-2 or N-to-N carriers handover situation. Because target secondary carriers are pre-assigned before handoff, the mobile station is ready for multi-carrier data transmission after handover operation without additional carrier assignment and activation procedures. In addition, if the mobile station has extra free RF carrier(s), it may perform ranging over the pre-assigned target secondary carrier(s) while performing ranging over the target primary carrier during handover. As a result, the mobile station is able to achieve better throughput during the multi-carrier handover operation with carrier pre-assignment.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 (Prior Art) illustrates system throughput during handover operation in a wireless multi-carrier OFDM network.

FIG. 2 illustrates carrier pre-assignment for multi-carrier handover in a wireless multi-carrier OFDM network in accordance with one novel aspect.

FIG. 3 illustrates carrier assignment procedure applied for call admission control in a wireless multi-carrier OFDM network.

FIG. 4 illustrates system overall throughput during handover operation with and without carrier pre-assignment in a wireless multi-carrier OFDM network.

FIG. 5 illustrates one embodiment of a handover request (HO-REQ) message for multi-carrier handover operation.

FIG. 6 illustrates one embodiment of a handover command (HO-CMD) message for multi-carrier handover operation.

FIG. 7 is a flow chart of a method of multi-carrier break-before-entry (BBE) handover operation in accordance with one novel aspect.

FIG. 8 illustrates a BBE handover procedure with carrier pre-assignment in a wireless multi-carrier OFDM network.

FIG. 9 is a message sequence chart of 2-to-2 RF carriers BBE handover procedure with carrier pre-assignment.

FIG. 10 is a message sequence chart of N-to-N RF carriers BBE handover procedure with carrier pre-assignment.

FIG. 11 is a flow chart of a method of multi-carrier entry-before-break (EBB) handover operation in accordance with one novel aspect.

FIG. 12 illustrates an EBB handover procedure with carrier pre-assignment in a wireless multi-carrier OFDM network.

FIG. 13 is a message sequence chart of 2-to-2 RF carriers intra-FA EBB handover procedure with carrier pre-assignment.

FIG. 14 is a message sequence chart of 2-to-2 RF carriers inter-FA EBB handover procedure with carrier pre-assignment.

FIG. 15 is a message sequence chart of N-to-N RF carriers intra-FA EBB handover procedure with carrier pre-assignment.

FIG. 16 is a message sequence chart of N-to-N RF carriers inter-FA EBB handover procedure with carrier pre-assignment.

FIG. 17 is an example of the 2-to-2 RF carriers BBE handover procedure with carrier pre-assignment being applied to the 3GPP Long Term Evolution (LTE) system with the support of carrier aggregation.

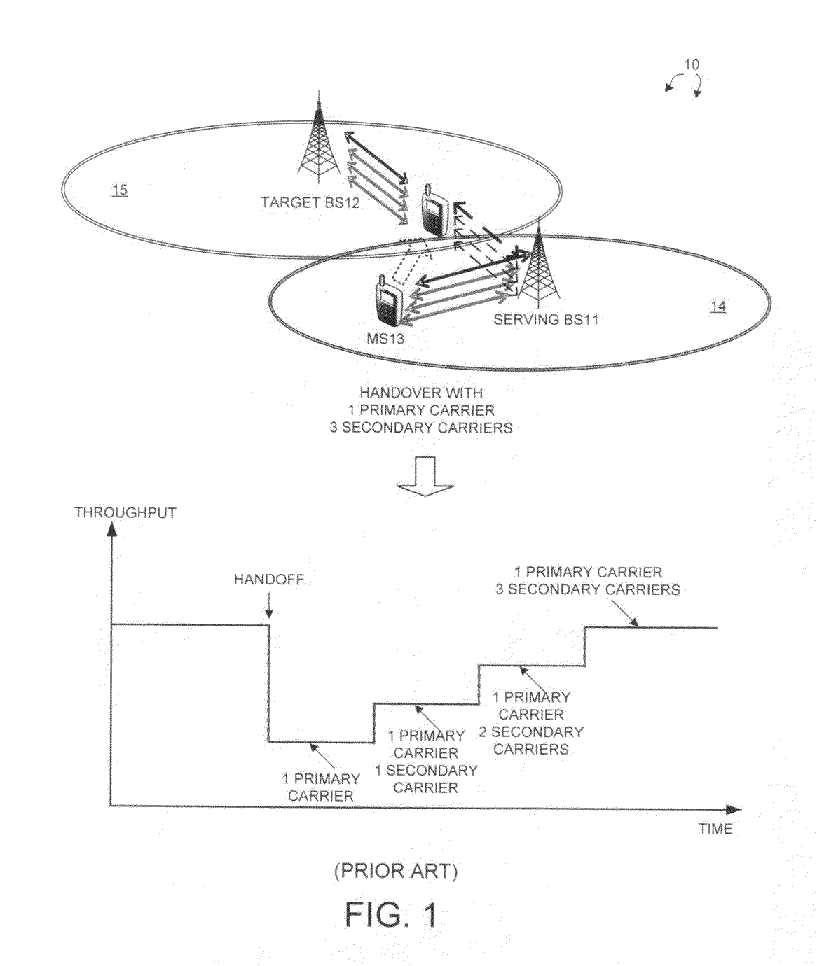

### DETAILED DESCRIPTION

Reference will now be made in detail to some embodiments of the invention, examples of which are illustrated in the accompanying drawings.

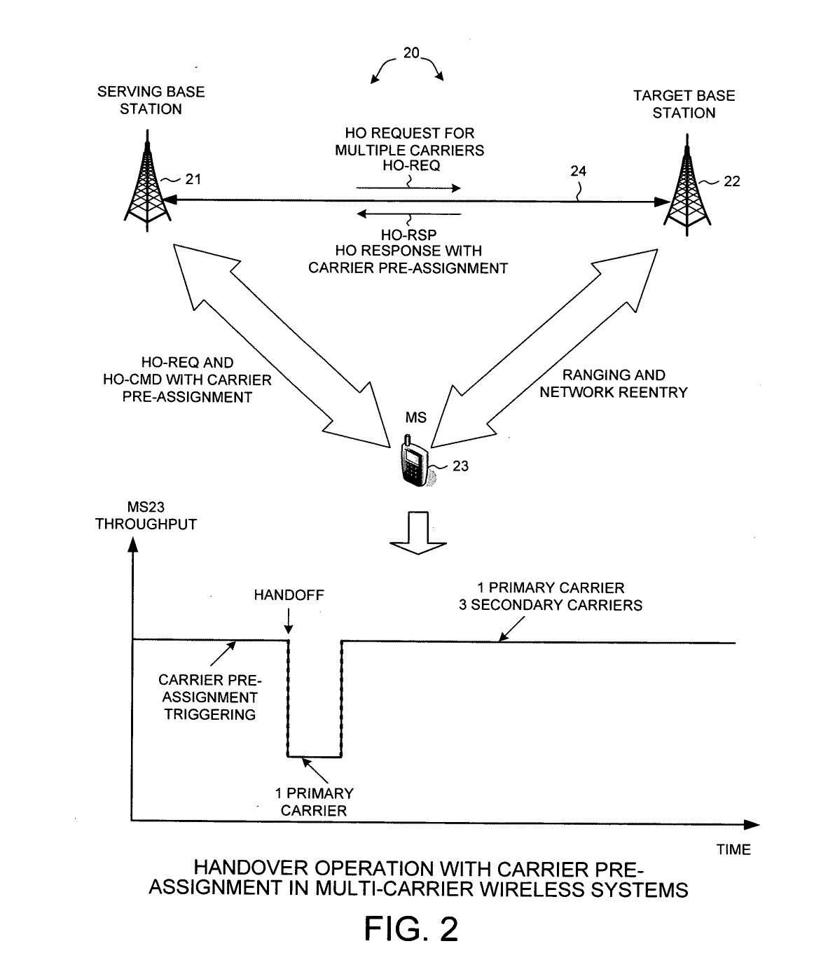

FIG. 2 illustrates carrier pre-assignment for multi-carrier handover in a wireless multi-carrier OFDM network 20 in accordance with one novel aspect. Multi-carrier OFDM network 20 comprises a serving base station SBS21, a target base station TBS22, and a mobile station MS23. MS23 is connected to serving SBS21 over a primary carrier as well as one or more secondary carriers. When MS23 moves away from serving SBS21, signal quality of the connections starts to degrade. A multi-carrier handover operation is then initiated either by serving SBS21 or by MS23 such that MS23 will be handover to target TBS22. In one novel aspect, serving SBS21 decides (or upon request from MS23) that MS23 needs carrier pre-assignment for the multi-carrier handover operation. SBS21 then forwards a handover request (HO-REQ) message to TBS22 via backend connection 24. The HO-REQ message comprises a carrier pre-assignment indication as well as multi-carrier information of MS23. After receiving the HO-REQ message, target TBS22 makes carrier pre-assignment decision for secondary carriers and transmits a handover response (HO-RSP) message to serving SBS21 via backend connection 24. SBS21 then transmits a handover command (HO-CMD) message with secondary carrier pre-assignment information to MS23. Upon receiving the HO-CMD message, MS23 performs handover ranging and network reentry with target TBS22 to complete the handover operation. As illustrated in FIG. 2, because target TBS22 pre-assigns secondary carriers for MS23 in advance of handoff, MS23 is able to establish connections with TBS22 over all the secondary carriers shortly after establishing connection over the primary carrier. MS23 thus no longer needs to follow normal carrier assignment and activation procedure for multi-carrier operation. As a result, the throughput of MS23 quickly increases after the primary carrier connection with target BS22 is established.

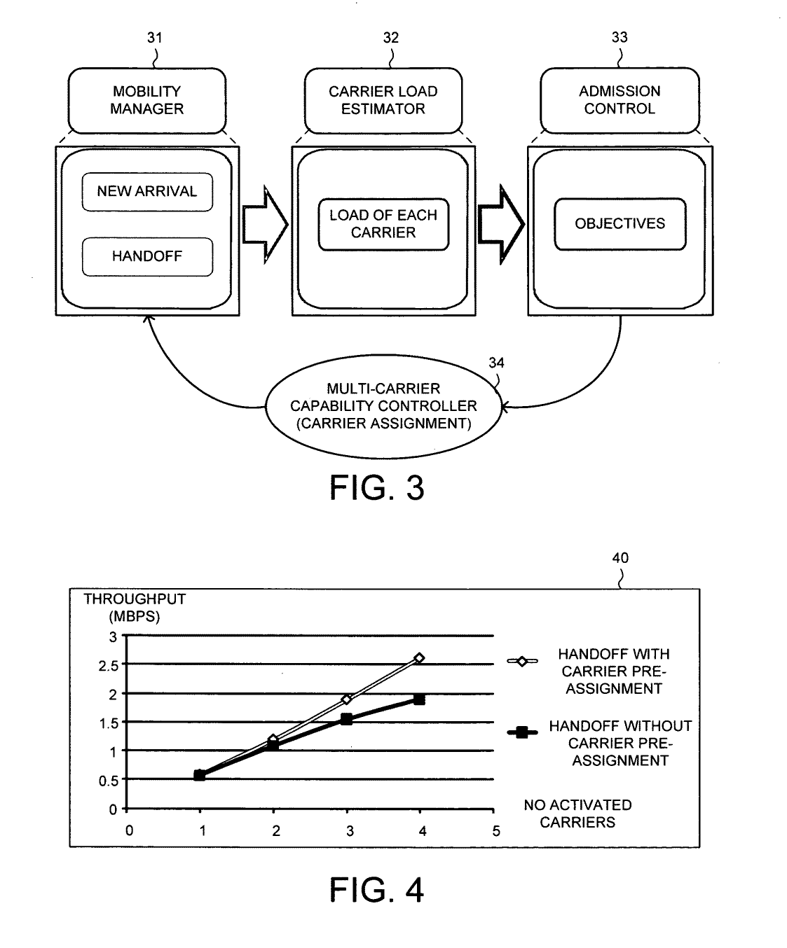

FIG. 3 illustrates carrier assignment procedure applied for call admission control in a wireless multi-carrier OFDM network. Call admission control in wireless networks aims to prevent traffic congestion and to provide good quality-of-services (QoS) for mobile users while efficiently utilize radio resource. Carrier assignment is a procedure that can be applied to achieve the objectives of call admission control. In the example of FIG. 3, mobility manager 31 of a base station first calculates the arrival rates of new mobile users and handoff mobile users. Carrier load estimator 32 of the base station then estimates the traffic load on each carrier based on the arrival rates. Call admission control module 33 of the base station then applies call admission control policy to achieve various objectives based on the traffic load on each carrier. For example, for each new arriving or handover mobile user, multi-carrier capability controller (carrier assignment) 34 of the base station calculates the utilities of each unblocking carrier. Multi-carrier capability controller 34 then assigns a carrier with the highest utility to the mobile user (if new arriving), or pre-assigns the carrier to the mobile user (if handover). Thus, the outcomes of carrier assignment or pre-assignment in turn directly influence future arrivals of mobile users on each carrier and help to achieve the objectives of call admission control.

FIG. 4 is a diagram 40 that illustrates simulation results of system overall throughput during multi-carrier handover operation with and without carrier pre-assignment in a wireless multi-carrier OFDM network. In the example of FIG. 4, the darker line represents the throughput (in Mbps) of a mobile user within the first ten frame cycles of a handover operation without carrier pre-assignment. On the other hand, the lighter line represents the throughput (in Mbps) of the mobile user within the first ten frame cycles of a handover operation with carrier pre-assignment. It can be seen that with carrier pre-assignment, the mobile user is able to achieve better throughput during handover operations. Furthermore, when the number of activated carriers increases, the throughput difference between with carrier pre-assignment and without carrier pre-assignment also increases.

In one novel aspect, a mobile station and a target base station negotiates their multi-carrier capability such that the target base station pre-assigns secondary carriers based on the negotiation result. Such negotiation is performed by exchanging handover request and handover command via a serving base station. First, the mobile station communicates its multi-carrier capability and requirements to the target base station via a handover request. Second, upon receiving the handover request, the target base station pre-assigns certain secondary carriers to fulfill the requirements of the mobile station. For example, the pre-assignment decision may be based on a combination of the multi-carrier capability and preference of the mobile station, its QoS requirement, the traffic load of each secondary carrier, and other call admission control policies.

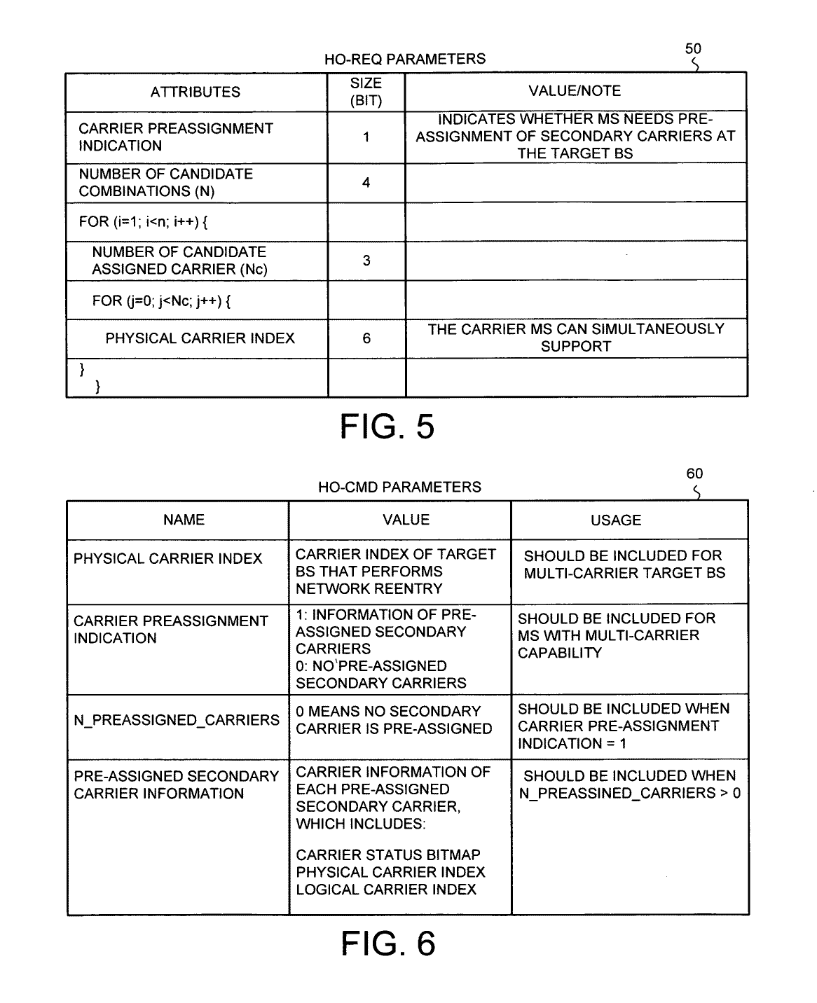

FIG. 5 illustrates one embodiment of a handover request (HO-REQ) message for multi-carrier handover operation. In the example of FIG. 5, a HO-REQ message comprises a carrier pre-assignment indication, and multi-carrier information of the mobile station. The carrier pre-assignment indicator indicates whether the mobile station needs pre-assignment for secondary carriers at the target base station. The multi-carrier information may include the number of possible multi-carrier combinations supported by the mobile station, the physical carrier index that the mobile station can simultaneously support for each combination, and other multi-carrier capabilities supported by the mobile station. Optionally, the multi-carrier information may also include the current status of carrier assignment and the quality of service (QoS) requirement of the mobile station. The mobile station may also recommend the secondary carriers to be pre-assigned during multi-carrier handover.

FIG. 6 illustrates one embodiment of a handover command (HO-CMD) message for multi-carrier handover operation. In the example of FIG. 6, a HO-CMD message comprises a physical carrier index of the target base station that performs network reentry with the mobile station, a carrier pre-assignment indication indicates whether information of pre-assigned secondary carriers is included in this message, the number of pre-assigned secondary carriers, and the actual information of the pre-assigned secondary carriers. If no secondary carrier is pre-assigned, then the number of pre-assigned secondary carriers is set to zero. On the other hand, if one or more secondary carriers are pre-assigned, then the information of each pre-assigned secondary carriers may include a carrier status bitmap, a physical carrier index, and a logical index. The carrier status bitmap indicates whether this pre-assigned secondary carrier will be activated immediately after handover operation is completed. The target base station may start data transmission on such activated carrier right after network reentry if the mobile station sends an indication message (AAI CM-IND) to the target base station indicates that the mobile station is now ready for data communication.

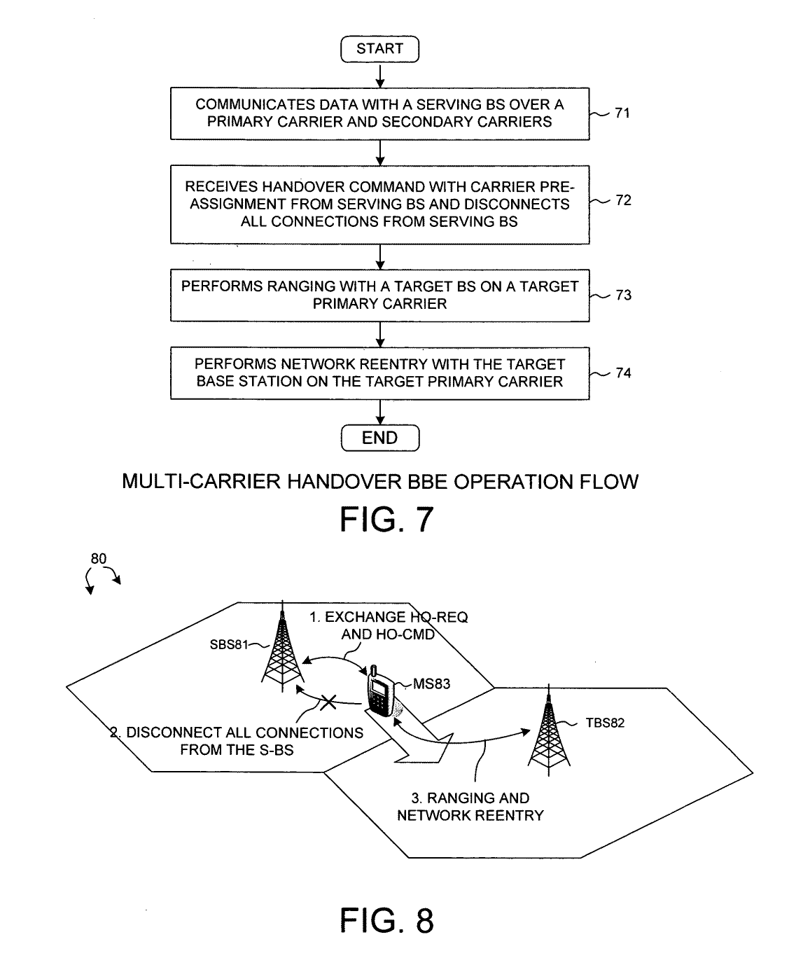

FIG. 7 is a flow chart of a method of multi-carrier break-before-entry (BBE) handover operation in accordance with one novel aspect. In step 71, a multi-carrier mobile station communicates with its serving base station over both a primary carrier and one or more secondary carriers. The MS receives a handover command from the serving base station and disconnects all connections from the serving BS (step 72). The handover command comprises carrier pre-assignment decision of a target base station. The MS then performs handover ranging and network reentry with the target BS on a target primary carrier (step 73). Finally, new connections on the target primary carrier and secondary carriers are established simultaneously (step 74).

FIG. 8 illustrates a multi-carrier BBE handover procedure with carrier pre-assignment in a multi-carrier OFDM network 80. Multi-carrier OFDM network 80 comprises a serving base station SBS81, a target base station TBS82, and a mobile station MS83. MS83 is initially connected to SBS81 over both a primary carrier and one or more secondary carriers. When MS83 moves away from SBS81 and closer to TBS82, a handover operation is then initiated either by serving SBS81 or by MS83 such that MS83 will be handover to target TBS82. After MS83 receives a handover command from SBS81 with carrier pre-assignment decision of TBS82, MS83 disconnects all connections from SBS81, and then performs ranging and network reentry with TBS82 over a target primary carrier. Because MS83 receives information on the pre-assigned target secondary carriers at TBS82 before handoff, data connections on target primary carrier and target secondary carriers are established simultaneously without additional carrier assignment and activation procedures.

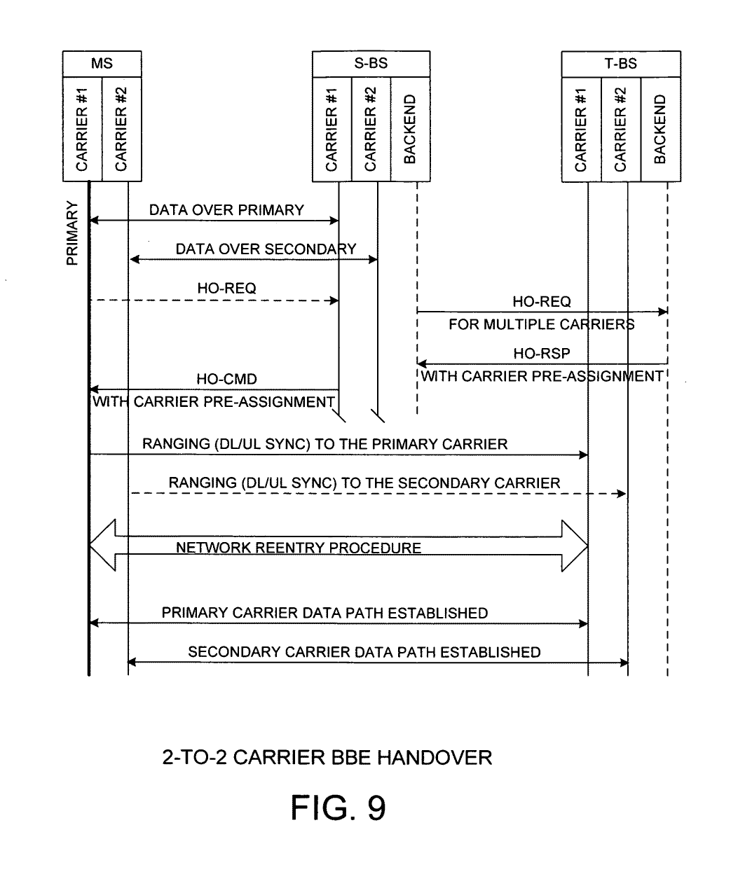

FIG. 9 is a detailed message sequence chart of a 2-to-2 carriers BBE handover procedure with carrier pre-assignment. In a 2-to-2 carriers handover situation, a mobile station (MS) communicates with its serving base station (S-BS) over both a primary carrier (carrier#1) and a secondary carrier (carrier#2), and both serving carriers will be handed over to two target carriers of a target base station (T-BS) after the completion of the 2-to-2 carriers handover operation. For MS-initiated handover, the MS and the S-BS exchange handover request (HO-REQ) message and handover command (HO-CMD) message via the primary carrier. For BS-initiated handover, the MS receives HO-CMD message from the S-BS. Because multi-carrier handover is involved, the S-BS forwards the HO-REQ message that contains multi-carrier information of the MS to the T-BS via backend, and receives a handover response (HO-RSP) message back from the T-BS via backend. The S-BS then forwards the HO-CMD message that contains carrier pre-assignment information of the T-BS to the MS. After receiving the HO-CMD message, the MS performs handover ranging (i.e. DL/UL synchronization) on the target primary carrier after disconnecting all connections from the S-BS. Furthermore, because the MS has already received information on a pre-assigned target secondary carrier, handover ranging on the target secondary carrier may either be performed or be skipped depending on the synchronization status. The MS then performs network reentry on the target primary carrier. New connections are thus established on both the target primary carrier and the target secondary carrier simultaneously without extra carrier assignment and activation procedures.

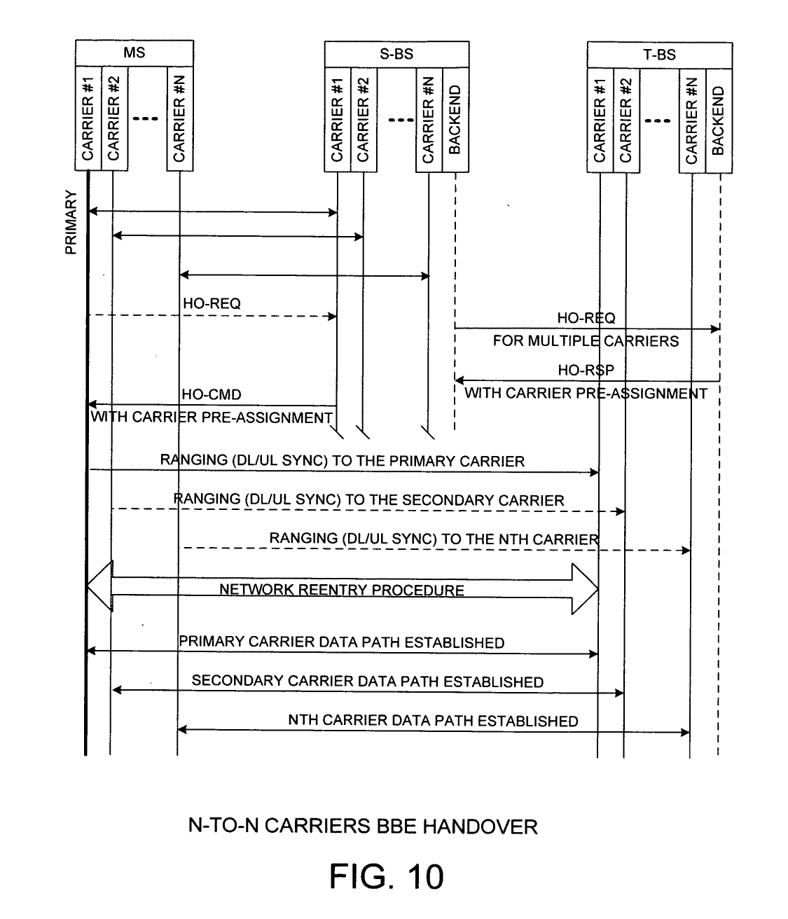

FIG. 10 is a detailed message sequence chart of an N-to-N carriers BBE handover procedure with carrier pre-assignment. In an N-to-N carrier handover situation, a mobile station (MS) communicates with its serving base station (S-BS) over N multiple carriers (carrier#1-#N), and all N serving carriers will be handed over to N target carriers of a target base station (T-BS) after the completion of the N-to-N carriers handover operation. The N-to-N carriers BBE handover procedure is similar to the 2-to-2 carriers BBE handover described above with respect to FIG. 9. It is noted that although ranging to the target primary carrier has to be performed after disconnecting all existing connections with the S-BS, additional ranging to other target secondary carriers may be optionally performed simultaneously because the MS has already received information on all the pre-assigned target secondary carriers via the HO-CMD message. Thus, all new connections on the target primary carrier and other target secondary carriers are established simultaneously after the network reentry on the target primary carrier.

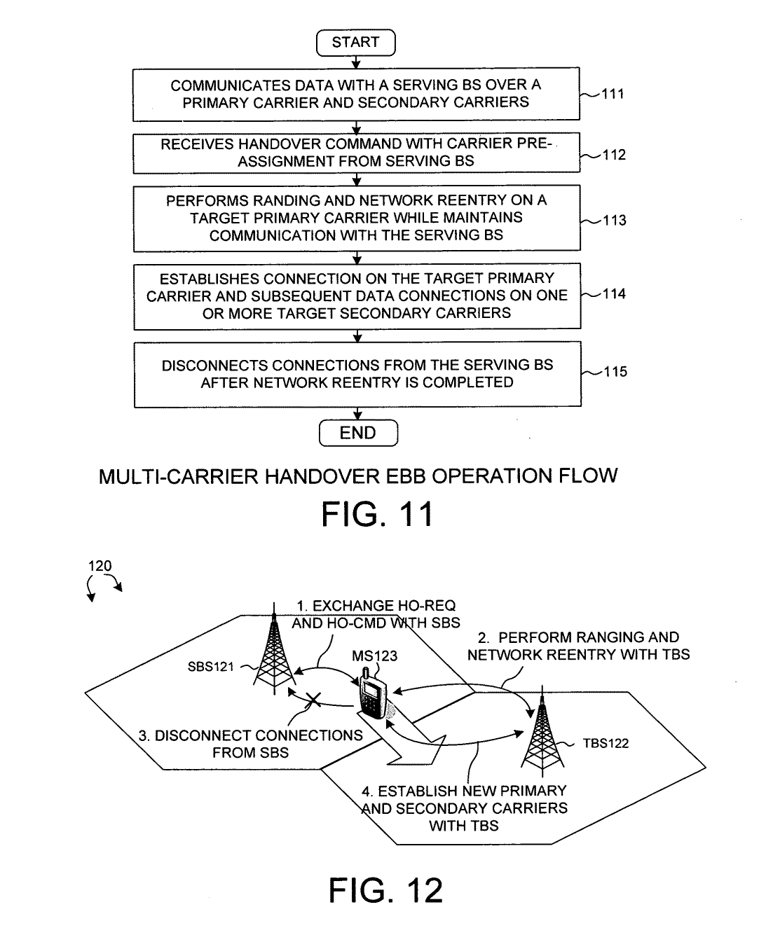

FIG. 11 is a flow chart of a method of multi-carrier entry-before-break (EBB) handover operation in accordance with one novel aspect. In step 111, a multi-carrier mobile station communicates with its serving base station over both a primary carrier and one or more secondary carriers. In step 112, the MS receives a handover command from the serving base station. The handover command comprises carrier pre-assignment decision of a target base station. The MS then performs handover ranging and network reentry with the target BS on a target primary carrier while maintains data communication with the serving BS (step 113). In step 114, the MS establishes a new connection on the target primary carrier and disconnects all connections from the serving BS. Finally, new connections on the target secondary carriers are established (step 115).

FIG. 12 illustrates a multi-carrier EBB handover procedure with carrier pre-assignment in a wireless multi-carrier OFDM network 120. Multi-carrier OFDM network 120 comprises a serving base station SBS121, a target base station TBS122, and a mobile station MS123. MS123 is initially connected to SBS121 over both a primary carrier and one or more secondary carriers. When MS123 moves away from SBS121 and closer to TBS122, a handover operation is then initiated either by serving SBS121 or by MS123 such that MS123 will be handover to target TBS122. After MS123 receives a handover command from SBS121 with carrier pre-assignment decision of TBS122, MS123 performs ranging and network reentry with TBS122 over a target primary carrier, while maintains communication with SBS121. Data connections are first established on target primary carrier, and subsequently on target secondary carriers. Because MS123 receives information of the pre-assigned secondary carriers at TBS122 before handoff, data connections on target secondary carriers are established without extra carrier assignment procedures.

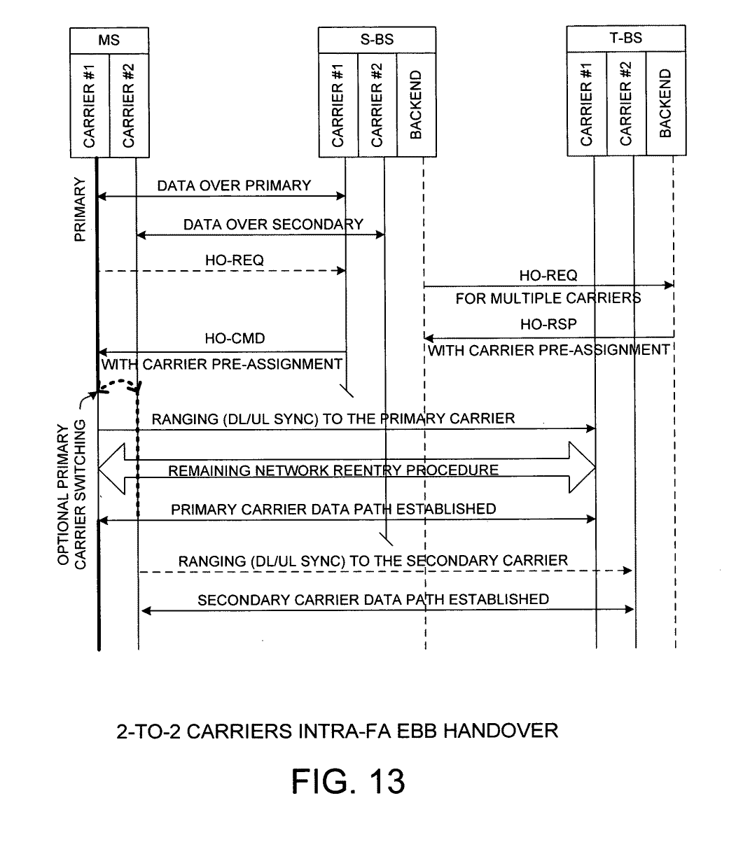

FIG. 13 is a detailed message sequence chart of a 2-to-2 RF carriers intra-FA EBB handover procedure with carrier pre-assignment. In a 2-to-2 carriers handover situation, a mobile station (MS) communicates with its serving base station (S-BS) over both a primary carrier (carrier#1) and a secondary carrier (carrier#2), and both serving carriers will be handed over to two target carriers after the completion of the 2-to-2 carriers handover operation. In MS-initiated handover, the MS and the S-BS exchange handover request (HO-REQ) message and handover command (HO-CMD) message via the primary carrier. In BS-initiated handover, the MS receives HO-CMD message from the S-BS. Because multi-carrier handover is involved, the S-BS forwards the HO-REQ message that contains multi-carrier information of the MS to the T-BS via backend, and receives a handover response (HO-RSP) message back from the T-BS via backend. The S-BS then forwards the HO-CMD message that contains carrier pre-assignment information of the T-BS to the MS. After receiving the HO-CMD message, the MS performs handover ranging (i.e. DL/UL synchronization) with the T-BS on one carrier while maintaining data connection with the S-BS on the other carrier. If the primary carrier is used for handover ranging, then primary carrier switching is conducted optionally before such ranging. The MS then performs the remaining network reentry procedure (i.e. key exchange, capability negotiation) with the T-BS and establishes a new connection to the T-BS on the target primary carrier. After the new connection has been established, handover ranging to the target secondary carrier may either be performed or skipped depending on the synchronization status and a new connection to the T-BS on the target secondary carrier is subsequently established. After the intra-FA handover, the original primary carrier remains as the new target primary carrier.

It is noted that in the example of FIG. 13, because the MS only has two RF carriers, ranging to the target secondary carrier has to be performed after establishing the new connection on the target primary carrier. Such ranging, however, may be performed right after the MS receives information of the pre-assigned target secondary carrier if the MS has another free RF carrier. Furthermore, because the MS as already received information of the pre-assigned target secondary carrier before handoff, the new connection on the target secondary carrier is established without extra carrier assignment procedures. From the S-BS perspective, it simply stops data transmission with the MS after the completion of the handover operation or upon expiration of disconnection time, whichever comes first.

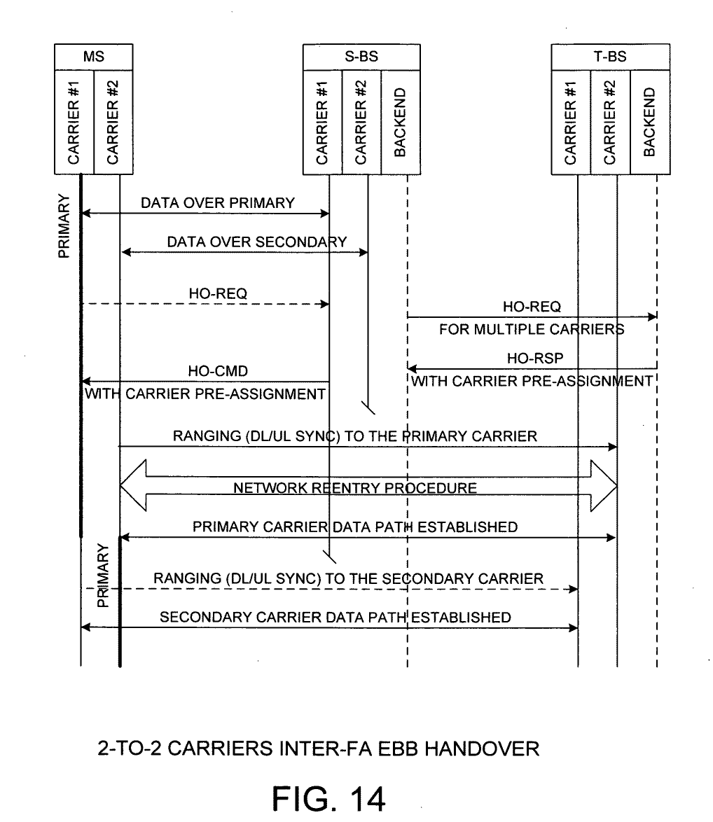

FIG. 14 is a detailed message sequence chart of a 2-to-2 RF carriers inter-FA EBB handover procedure with carrier pre-assignment. The inter-FA EBB handover procedure is very similar to the intra-FA EBB handover procedure described above with respect to FIG. 13. The difference is that the MS maintains connection with the S-BS on the primary carrier (carrier #1) while performing handover ranging with the T-BS on the secondary carrier (carrier #2) and thus no primary carrier switch is needed. After the inter-FA handover, the secondary carrier becomes the new target primary carrier.

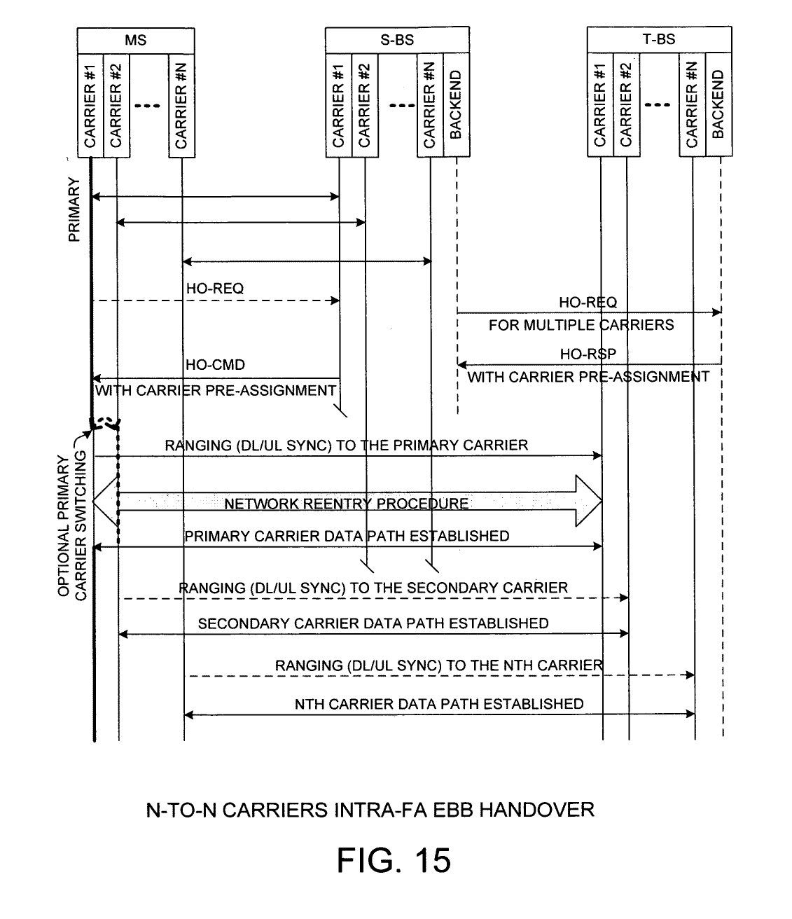

FIG. 15 is a detailed message sequence chart of an N-to-N RF carriers intra-FA EBB handover procedure with carrier pre-assignment. In an N-to-N carrier handover situation, a mobile station (MS) communicates with its serving base station (S-BS) over N multiple carriers (carrier#1-#N), and all N serving carriers will be handed over to N target carriers after the completion of the N-to-N carriers handover operation. The N-to-N carriers intra-FA EBB handover procedure is similar to the 2-to-2 carriers intra-FA EBB handover described above with respect to FIG. 13, and all carriers connecting to the serving BS are disconnected right after the target primary carrier is established.

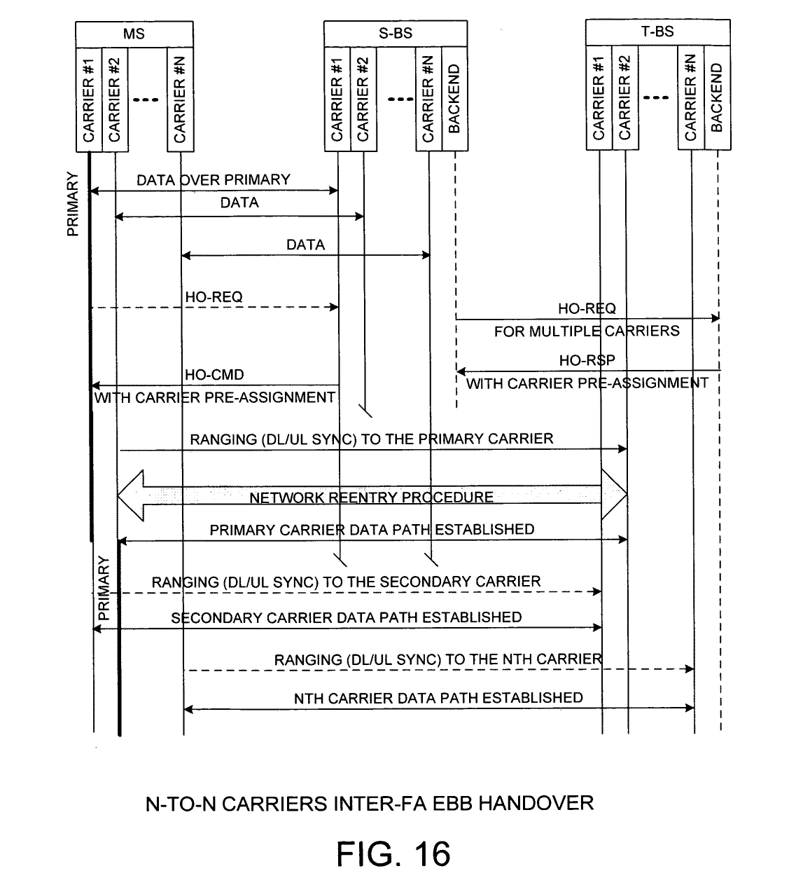

FIG. 16 is a detailed message sequence chart of an N-to-N RF carriers inter-FA EBB handover procedure with carrier pre-assignment. The N-to-N carriers inter-FA EBB handover procedure is similar to the 2-to-2 carriers inter-FA EBB handover described above with respect to FIG. 14, and all carriers connecting to the serving BS are disconnected right after the target primary carrier is established.

For additional details on the multi-carrier handover procedure, see: U.S. patent application Ser. No. 12/456,006 entitled “Scanning and Handover Operation in Multi-Carrier Wireless Communications Systems”, filed on Jun. 9, 2009, by Chao-Chin Chou et al. (the subject matter of which is incorporated herein by reference).

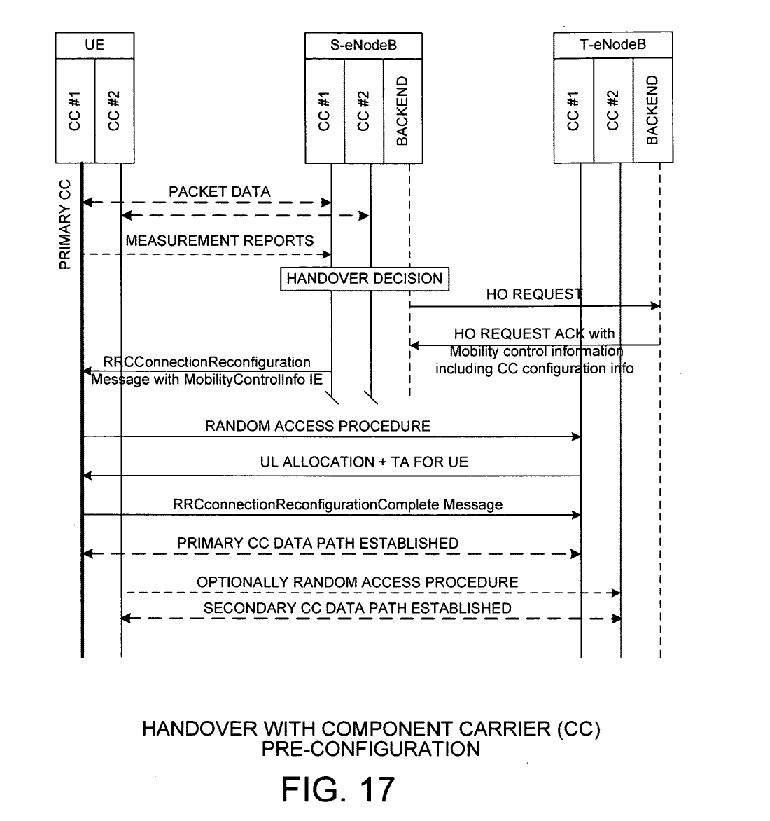

While the above-illustrated embodiments are made only with respect to WiMAX OFDM networks, the multi-carrier handover procedure with carrier pre-assignment is applicable for both WiMAX and LTE-advanced wireless systems. FIG. 17 is an example of the 2-to-2 carriers BBE handover procedure with carrier pre-assignment (also referred to as pre-configuration) being applied to the 3GPP Long Term Evolution (LTE) system. In the example of FIG. 17, an UE (User Equipment) communicates with its serving eNodeB (E-UTRAN NodeB) over both a primary CC (component carrier) and a secondary CC, and both serving CCs will be handed over to two target CC of a target eNodeB after the completion of the 2-to-2 carriers handover operation. The serving eNodeB sends handover request message to the target eNodeB via backend for handover preparation. The target eNodeB responses with a handover request acknowledgement message, which contains necessary information for the UE's network re-entry to the target eNodeB, and the information of the pre-assigned (pre-configured) CCs for the UE. After receiving the handover request acknowledgement message from the target eNodeB, the serving eNodeB send an RRCConnectionReconfiguration message with the MobilityControllnfo IE (information element) to the UE as a handover command. The MobilityControllnfo IE includes the information for handover and CC pre-assignment (pre-configuration) prepared by the target eNodeB. After receiving the RRCConnectionReconfiguration message with MobilityControllnfo IE, the UE performs random access procedure to the target primary CC after disconnecting all connections from the serving eNodeB. Because the UE has already received information on the pre-assigned (pre-configured) target secondary CC, random access procedure on the target secondary CC may either be performed or be skipped depending on the synchronization status and the need of readiness indication. Therefore, the secondary CC connection can be established right after the primary CC without extra carrier assignment (configuration) procedures at the target eNodeB.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1. A method of handover in a multi-carrier wireless OFDM system, the method comprising:
(a) receiving a handover request by a target base station, wherein the handover request comprises multi-carrier information of a mobile station;
(b) transmitting a handover response that comprises multi-carrier pre-assignment decision of the target base station;
(c) performing synchronization and network reentry on a target primary carrier and thereby establishing data connection on the target primary carrier with the mobile station; and
(d) establishing data connection on one or more target secondary carriers with the mobile station based on the multi-carrier pre-assignment decision.

2. The method of claim 1, wherein the target base station receives carrier capability and preference communicated from the mobile station using the multi-carrier information via a serving base station.

3. The method of claim 2, wherein the target station communicates the carrier assignment decision to the mobile station via the serving base station.

4. The method of claim 1, wherein the target base station makes the carrier pre-assignment decision based at least in part on the multi-carrier information.

5. The method of claim 1, wherein the target base station makes the carrier pre-assignment decision based on call admission control policies applied in the wireless OFDM system.

6. The method of claim 1, wherein the multi-carrier pre-assignment decision comprises a total number of pre-assigned secondary carriers at the target base station.

7. The method of claim 6, wherein the multi-carrier pre-assignment decision comprises a carrier index of each pre-assigned secondary carrier.

8. The method of claim 6, wherein the multi-carrier pre-assignment decision comprises a carrier status bitmap that indicates whether a pre-assigned secondary carrier is activated right after network reentry.

9. A method of operating a mobile station to handover from a serving base station to a target base station in a multi-carrier wireless OFDM system, the method comprising:
(a) communicating data with the serving base station over a primary carrier and one or more secondary carriers;
(b) receiving a handover command from the serving base station and disconnecting all connections from the serving base station, wherein the handover command comprises multi-carrier pre-assignment decision of the target base station;
(c) performing ranging with the target base station on a target primary carrier; and
(d) performing network reentry on the target primary carrier and thereby establishing connections on both the target primary carrier and one or more target secondary carriers simultaneously.

10. The method of claim 9, further comprising:
performing ranging with the target base station on the one or more target secondary carriers.

11. The method of claim 9, wherein the ranging and network reentry is performed over the primary carrier, which becomes the target primary carrier.

12. The method of claim 9, wherein multi-carrier information of the mobile station is forwarded by the serving base station to the target base station before the target base station makes multi-carrier pre-assignment decision.

13. The method of claim 12, wherein the mobile station communicates carrier capability and preference to the target base station via the multi-carrier information.

14. The method of claim 12, wherein the carrier pre-assignment decision is determined based at least in part on the multi-carrier information of the mobile station.

15. A method of operating a mobile station to handover from a serving base station to a target base station in a multi-carrier wireless OFDM system, the method comprising:
(a) communicating data with the serving base station over a primary carrier and one or more secondary carriers;
(b) receiving a handover command from the serving base station via the primary carrier, wherein the handover command comprises multi-carrier pre-assignment decision of the target base station;
(c) performing ranging and network reentry on a target primary carrier while maintaining communications with the serving base station;
(d) establishing data connection on the target primary carrier and subsequent data connection on one or more target secondary carriers; and
(e) disconnecting all connections on all carriers from the serving base station after data connection on the target primary carrier is established.

16. The method of claim 15, further comprising:
performing ranging with the target base station on the one or more target secondary carriers.

17. The method of claim 15, wherein the ranging and network reentry is performed over the primary carrier, which becomes the target primary carrier.

18. The method of claim 15, wherein the ranging and network reentry is performed over the secondary carrier, which becomes the target primary carrier.

19. The method of claim 15, wherein multi-carrier information of the mobile station is forwarded by the serving base station to the target base station before the target base station makes multi-carrier pre-assignment decision.

20. The method of claim 19, wherein the mobile station communicates carrier capability and preference to the target base station via the multi-carrier information.

21. The method of claim 19, wherein multi-carrier pre-assignment decision is determined based at least in part on the multi-carrier information of the mobile station.
